(19) United States
(12) Patent Application Publication
(10) Pub. No.: US 2024/0045393 A1
(43) Pub. Date: Feb. 8, 2024

(54) Process Monitoring System

(71) Applicant: SICK AG, Waldkirch (DE)

(72) Inventor: Stefan SCHWEIGER, Teningen (DE)

(21) Appl. No.: 18/229,721

(22) Filed: Aug. 3, 2023

(30) Foreign Application Priority Data
Aug. 4, 2022 (DE) 102022119620.8

(51) Int. Cl. G05B 19/042

(52) U.S. Cl. CPC G05B 19/0428; G05B 2219/15052

(57) ABSTRACT

The present invention relates to a process monitoring system for monitoring an industrial process, said process monitoring system comprising a main sensor and at least one additional sensor separate from the main sensor, wherein the process monitoring system furthermore comprises a data evaluation unit separate from the sensors, wherein the main sensor and the additional sensor are each configured to acquire measurement data. The main sensor is coupled to the additional sensor via a first data link and is configured to receive the measurement data of the additional sensor via the first data link, wherein the main sensor is coupled to the data evaluation unit via a second data link and is configured to transmit its own measurement data and the measurement data of the additional sensor to the data evaluation unit via the second data link.

The present invention relates to a process monitoring system for monitoring an industrial process, said process monitoring system comprising a main sensor and at least one additional sensor separate from the main sensor.

Due to rising energy costs, for example for compressed air, power, industrial gases and/or water, more and more industrial processes are being monitored by means of sensors. For example, the consumption of compressed air can then be monitored by means of the sensors, wherein leaks in the compressed air lines can in particular also be determined.

Due to the increasing number of sensors in industrial processes, the challenge is to enable a simple integration of such sensors or consumption meters into existing data processing systems.

Typically, programmable logic controllers (PLCs) are used for this purpose that receive measurement data of the individual sensors, bundle and forward said data e.g. to computer systems for data evaluation. Due to this infrastructure, many different components additionally have to be installed and maintained, for example the programmable logic controller itself or the energy supply for the programmable logic controller. In addition, there is the development effort for the corresponding programming of the programmable logic controller. These additional components and the additional development effort cause costs, require time and space, and are therefore disadvantageous.

It is therefore the underlying object of the invention to specify a process monitoring system that enables a simple and cost-effective connection of sensors for monitoring an industrial process.

This object is satisfied by a process monitoring system in accordance with claim 1.

The process monitoring system in accordance with the invention serves to monitor an industrial process. The process monitoring system comprises a main sensor and at least one additional sensor separate from the main sensor. Furthermore, the process monitoring system comprises a data evaluation unit separate from the sensors. The main sensor and the additional sensor are configured to acquire measurement data that preferably reflect the state of the industrial process. The main sensor is coupled to the additional sensor via a first data link and is configured to receive the measurement data of the additional sensor via the first data link. The main sensor is furthermore coupled to the data evaluation unit via a second data link and is configured to transmit its own measurement data and the measurement data of the additional sensor to the data evaluation unit via the second data link.

The invention is based on the recognition that the main sensor, which is present anyway, can be used not only to transmit its own measurement data to the data evaluation unit, but can additionally be used to receive the measurement data of the additional sensor and forward said data to the data evaluation unit (e.g. a cloud). In this way, the expense of a PLC can be saved, whose sole purpose is, for example, to receive the measurement data of the additional sensor and forward said data to the data evaluation unit. It is understood that sufficient resources must for this purpose be available in the main sensor for receiving and forwarding the measurement data.

In the following, only one additional sensor is usually mentioned. However, it is equally possible for the main sensor to be coupled to a plurality of additional sensors via data links and to receive the measurement data of the plurality of additional sensors and to transmit said data to the data evaluation unit. The explanations included herein regarding the one additional sensor apply accordingly to a plurality of additional sensors in each case.

In other words, the main sensor is therefore, on the one hand, connected to the additional sensor via the first data link and receives its measurement data from the additional sensor. In the main sensor, the measurement data of the additional sensor can then be converted so that they can be transmitted to the data evaluation unit. For this purpose, the main sensor is connected to the data evaluation unit via the second data link and can transmit both its own measurement data and the measurement data of the additional sensor to the data evaluation unit.

Advantageous further developments of the invention can be seen from the description, from the Figures, and from the dependent claims.

In accordance with a first embodiment, the first and the second data link comprise different hardware interfaces at the main sensor. The main sensor can therefore comprise a first hardware interface for the first data link and a second hardware interface, which is different from the first hardware interface, for the second data link. The hardware interfaces are in particular not compatible with one another. The main sensor can therefore, for example, receive the measurement data of the additional sensor in a specific data format, wherein the main sensor can change the data format such that a transmission to the data evaluation unit is possible.

In accordance with a further embodiment, the first data link is configured to transmit measurement data by means of pulse sequences. In this respect, the first data link (and/or the associated hardware interface of the main sensor) in particular comprises an S0 pulse interface. A transmission by means of a pulse sequence does not place high demands on the additional sensor so that such a data transmission can also be integrated into small and inexpensive sensors. The pulse sequence can in particular be transmitted electrically, by means of electrical lines, or also optically, for example by means of an infrared signal. Accordingly, the main sensor can have an electrical connector and/or an infrared interface as the hardware interface for the first data link. The electrical connector can e.g. be a multipoint plug having a screw thread. The infrared interface can be attached directly to the housing of the main sensor by means of a magnetic fixation, for example. Furthermore, the hardware interface for the first (and/or also the second) data link can comprise a glass fiber having a corresponding plug-in space in the housing of the main sensor. Via the glass fiber, the measurement data can e.g. be transmitted via optical Ethernet.

In particular the S0 pulse interface is often integrated in simple energy meters and/or volume meters and/or water meters. With this interface, electrical pulses with, for example, 30 V or 27 V are used for data transmission.

There can in particular be a direct, in particular an electrical, data link between the additional sensor and the main sensor, for example the aforementioned electrical line, so that the measurement data can arrive at the main sensor in pulse-coded form.

When using pulse sequences, e.g. the number of pulses per unit can be specified, in particular by a user. For example, 800 pulses can correspond to one kilowatt hour (kWh) each. Alternatively, 400 pulses can, for example, correspond to one standard cubic meter each. In addition, the user can set, in particular in the main sensor, the start value and/or the unit (kilowatt hour, cubic meters, degrees Celsius and the like) of the respective measurement data of the additional sensor connected to a specific hardware interface. In the main sensor, the measurement data received from the additional sensor can be treated internally as a process variable (i.e. like a measurement value of the main sensor itself) and can in particular ultimately be made available to the data evaluation unit.

Alternatively or in addition to the S0 pulse interface, a data transmission by means of M-Bus (also called Meter-Bus) or by means of Smart Message Language (SML) can also take place. Other methods of data transmission are likewise possible. It is understood that these alternative or additional data transmission methods are to be considered as an alternative or as an addition whenever the S0 pulse interface is mentioned herein.

In accordance with an alternative embodiment, the first data link comprises a gateway to which the additional sensor is connected, wherein the main sensor is configured to receive and/or retrieve the measurement data of the additional sensor from the gateway. The gateway can be connected to the main sensor by means of the first data link. In turn, a plurality of additional sensors can be connected to the gateway, wherein the main sensor receives and/or retrieves the measurement data of some or all of the additional sensors from the gateway. In this case, there is no direct data link between the additional sensor and the main sensor.

In accordance with a further embodiment, the additional sensor is configured to transmit its measurement data to the gateway by means of pulse sequences, in particular by means of an S0 pulse interface, wherein the gateway and the main sensor are connected to one another by means of a first data link designed as an Ethernet connection. The above statements on the transmission of the measurement data by means of a pulse sequence between the additional sensor and the main sensor apply accordingly to the transmission of the measurement data by means of a pulse sequence to the gateway.

The gateway can in particular be an S0 gateway that transfers the measurement data received by means of pulse sequences to an Ethernet connection so that the measurement data can be transmitted to the main sensor by means of the Ethernet connection. For this purpose, a client can be executed on the main sensor that obtains or retrieves the measurement data from the gateway and transmits said data to the main sensor.

In accordance with a further embodiment, the second data link is an Ethernet connection. As a hardware interface, the main sensor can comprise an Ethernet interface for this purpose. If the gateway is also communicated with via Ethernet, the main sensor does not have to have two different hardware interfaces, but can in particular comprise only one Ethernet interface via which the first data link to the gateway and the second data link to the data evaluation unit are established.

The Ethernet connections referred to herein can in particular be Ethernet connections with power transmission (Power over Ethernet, PoE). The sensors can thus be supplied with electrical energy via the Ethernet connections.

Via the Ethernet connection, the main sensor can transmit its own measurement data and the measurement data of the additional sensor(s) by Ethernet to the data evaluation unit, wherein, for example, an Ethernet-based fieldbus, the HTTP protocol or HTTPs protocol, a web server, the MQTT protocol (Message Queuing Telemetry Transport), or OPC UA (Open Platform Communications Unified Architecture) are used.

Due to the fact that the main sensor provides both its own measurement data and the measurement data of the additional sensor to the data evaluation unit, the main sensor can be configured to integrate and/or embed the measurement data of the additional sensor into its own data model. This simplifies the provision of the measurement data for the data evaluation unit. When implementing the process monitoring system, there is furthermore the advantage that only a single data end point (namely the main sensor), from which all the measurement data can be retrieved/received, has to be set up for the data evaluation unit. Separate communication settings of the data evaluation unit for each additional sensor can therefore be saved.

In accordance with a further embodiment, the main sensor has a computing device that is configured to execute a web server, wherein the computing device is additionally configured to transmit the measurement data of the main sensor and the additional sensor to the data evaluation unit. The web server can enable the representation of the measurement data of the main sensor and also of the additional sensor. The computing device that is thus anyway provided in the main sensor can then also be used to transmit the measurement data of the main sensor and the additional sensor to the data evaluation unit. Before the transmission, calculations on the measurement data and/or adaptations of the transmission format can be performed by the computing device. The web server can, for example, be reached via the HTTP protocol or the HTTPs protocol via the first and/or second data link.

It is understood that the main sensor can also comprise a computing device when the main sensor cannot execute a web server.

In accordance with a further embodiment, the main sensor, the additional sensor, and the data evaluation unit are arranged spatially separately from one another and are in particular each integrated in separate housings. The main sensor, the additional sensor, and the data evaluation unit can thus be independent devices, wherein the main sensor and/or the additional sensor can be configured as field devices, for example. The main sensor and the additional sensor can in particular be arranged several meters apart. Distances between the main sensor and the data evaluation unit can be even significantly greater, for example several 100 m or several kilometers.

In accordance with a further embodiment, the main sensor and the additional sensor are configured to acquire mutually different physical variables as measurement data. The sensors therefore acquire different measurement parameters.

In accordance with one embodiment, the main sensor can be a flow sensor that is preferably a thermal flow meter, in particular for compressed air. The main sensor can accordingly operate in accordance with the calorimetric principle of operation. The main sensor can comprise a sensor probe that is heated. The medium flowing past the sensor probe cools the sensor probe, wherein the temperature drop can be proportional to the flow velocity. The volume, for example of compressed air, flowing through the main sensor can thus be determined from the temperature drop.

In accordance with a further embodiment, the additional sensor is an electricity meter or a water meter. The additional sensor can, for example, monitor how much electrical energy a consumer in the industrial process has required or what volume of water or of another liquid has been consumed in the industrial process. The measurement data of the additional sensor, that is, for example, the amount of electrical energy or of consumed water, can then be transmitted to the main sensor at regular intervals (for example, every 5, 10, 30, or 60 seconds) via the first data link.

In accordance with a further embodiment, the data evaluation unit is formed by an edge computer or a cloud computer. The edge computer can, for example, be a computer that is arranged near the sensors, e.g. in the same factory hall. The cloud computer can be accommodated far away from the industrial process, for example in a server farm. The connection to the edge computer or the cloud computer can in each case be made possible via an Ethernet network that implements the second data link. The data evaluation unit can receive the measurement data of the various sensors, can perform calculations on said measurement data, can evaluate the measurement data and/or forward the measurement data to a process system or management system.

A further subject of the invention is a sensor, called a “main sensor” here in accordance with the previous embodiments, for a process monitoring system for monitoring an industrial process, wherein the main sensor is configured to acquire measurement data. The main sensor can be coupled to an additional sensor via a first data link and is configured to receive measurement data of the additional sensor via the first data link. Furthermore, the main sensor can be coupled to a data evaluation unit via a second data link and is configured to transmit its own measurement data and the measurement data of the additional sensor to the data evaluation unit via the second data link.

A further subject of the invention is a method for monitoring an industrial process using a main sensor and at least one additional sensor separate from the main sensor, wherein the main sensor and the additional sensor each acquire measurement data. The main sensor is coupled to the additional sensor via a first data link and receives the measurement data of the additional sensor via the first data link. The main sensor is coupled to a data evaluation unit via a second data link and transmits its own measurement data and the measurement data of the additional sensor to the data evaluation unit via the second data link.

The statements on the process monitoring system in accordance with the invention apply accordingly to the main sensor in accordance with the invention and to the method in accordance with the invention. This in particular applies with respect to advantages and preferred embodiments. It is furthermore understood that all the features and embodiments mentioned herein can be combined with one another, unless explicitly stated otherwise.

The invention will be described purely by way of example with reference to the drawings in the following. There are shown:

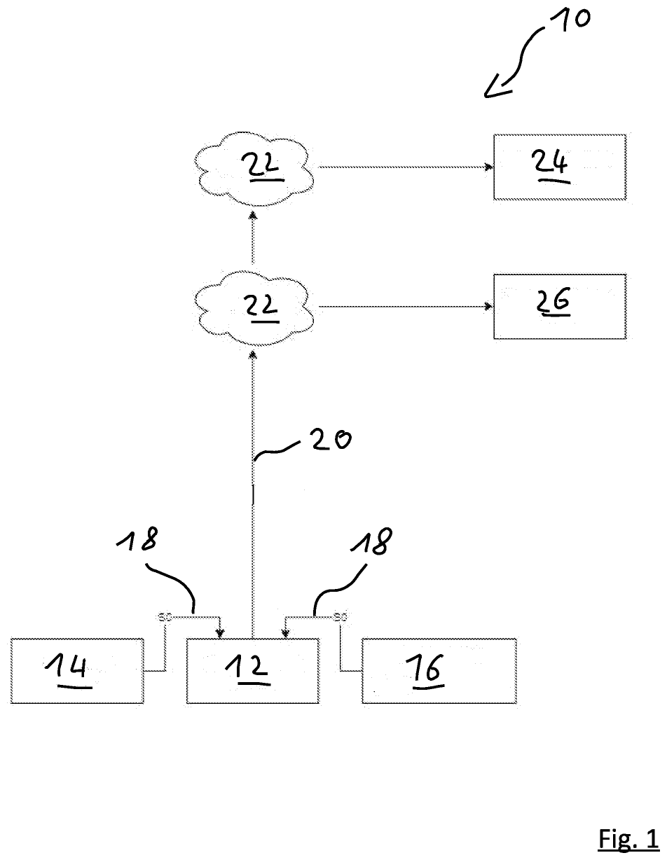

FIG. 1 a first embodiment of a process monitoring system; and

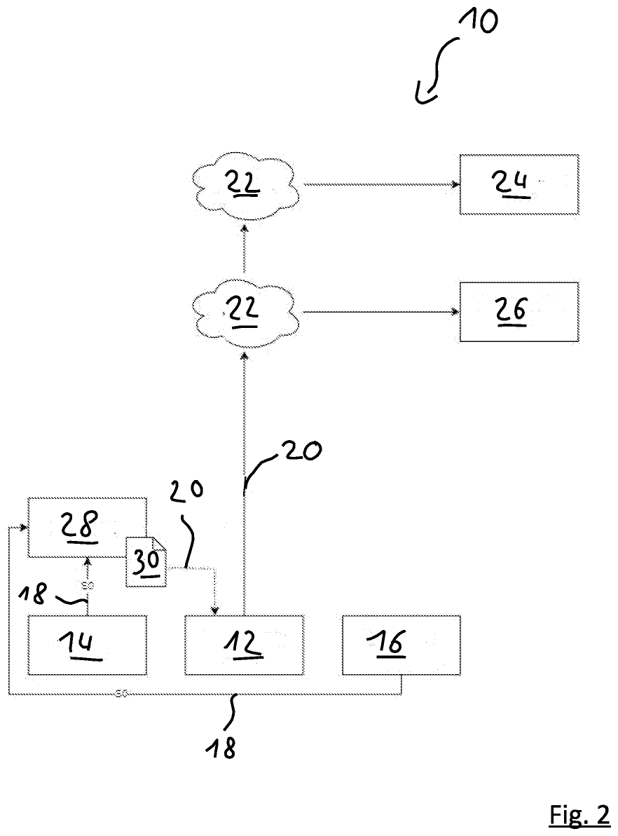

FIG. 2 a second embodiment of a process monitoring system.

FIG. 1 shows a process monitoring system 10 comprising a main sensor 12 configured as a flow sensor for compressed air. The main sensor 12 is connected to a first additional sensor 14 and a second additional sensor 16. The first additional sensor 14 is an electrical meter, whereas the second additional sensor 16 is a water meter.

The sensors 12, 14, 16 monitor an industrial process (not shown), wherein, for example, the main sensor 12 has a passage for compressed air in which a heated sensor probe is arranged.

The additional sensors 14, 16 are connected to the main sensor 12 via S0 pulse interfaces 18. The S0 pulse interfaces thus form the first data link mentioned above.

The main sensor 12 comprises a second data link in the form of an Ethernet connection 20 that connects the main sensor 12 to an Ethernet network 22. A data evaluation unit that comprises a cloud data evaluation 24 and/or an edge data evaluation 26 is connected to the Ethernet network 22.

During operation of the process monitoring system 10, the additional sensors 14, 16 regularly transmit measurement data to the main sensor 12 via the S0 pulse interface 18. The main sensor 12 then converts the measurement data of the additional sensors 14, 16 such that the measurement data can be transmitted to the cloud data evaluation 24 and/or the edge data evaluation 26 via the Ethernet connection 20. In addition to the measurement data of the additional sensors 14, 16, the main sensor 12 also transmits its own measurement data to the cloud data evaluation 24 and/or the edge data evaluation 26.

FIG. 2 shows an alternative embodiment of the process monitoring system 10. The embodiment in accordance with FIG. 2 differs from the embodiment in accordance with FIG. 1 in that the additional sensors 14, 16 are connected to a gateway 28 by means of the S0 pulse interfaces 18. The gateway 28 provides the measurement data of the additional sensors 14, 16 via an interface 30 for retrieval by means of the Ethernet connection 20. The main sensor 12 then retrieves the measurement data of the additional sensors 14, 16 from the gateway 28 via the interface 30 and transmits its own measurement data and/or the measurement data of the additional sensors 14, 16 to the cloud data evaluation 24 and/or the edge data evaluation 26, as described above.

In both embodiments, the intermediate connection of an expensive and complex programmable logic controller for acquiring the measurement data of the additional sensors 14, 16 can be avoided. Furthermore, the data evaluation 24, 26 only has to communicate with the main sensor, whereby a simple and inexpensive possibility for process monitoring with a plurality of sensors results.

### REFERENCE NUMERAL LIST

10 process monitoring system
12 main sensor
14 first additional sensor
16 second additional sensor
18 S0 pulse interface
20 Ethernet connection
22 Ethernet network
24 cloud data evaluation
26 edge data evaluation
28 gateway
30 interface

1. A process monitoring system for monitoring an industrial process, said process monitoring system comprising a main sensor and at least one additional sensor separate from the main sensor,
wherein the process monitoring system furthermore comprises a data evaluation unit separate from the sensors,
wherein the main sensor and the additional sensor are each configured to acquire measurement data,
wherein the main sensor is coupled to the additional sensor via a first data link and is configured to receive the measurement data of the additional sensor via the first data link,
wherein the main sensor is coupled to the data evaluation unit via a second data link and is configured to transmit its own measurement data and the measurement data of the additional sensor to the data evaluation unit via the second data link.

2. The process monitoring system in accordance with claim 1,
wherein the first and the second data link comprise different hardware interfaces at the main sensor.

3. The process monitoring system in accordance with claim 1,
wherein the first data link is configured to transmit measurement data by means of pulse sequences.

4. The process monitoring system in accordance with claim 3,
wherein the first data link comprises an S0 pulse interface and/or a data transmission by means of M-Bus and/or by means of Smart Message Language.

5. The process monitoring system in accordance with claim 1,
wherein the first data link comprises a gateway to which the additional sensor is connected, wherein the main sensor is configured to receive and/or retrieve the measurement data of the additional sensor from the gateway.

6. The process monitoring system in accordance with claim 5,
wherein the additional sensor is configured to transmit its measurement data to the gateway by means of pulse sequences, wherein the gateway and the main sensor are connected to one another by means of a first data link designed as an Ethernet connection.

7. The process monitoring system in accordance with claim 6,
wherein the additional sensor is configured to transmit its measurement data to the gateway by means of pulse sequences by means of an S0 pulse interface.

8. The process monitoring system in accordance with claim 5,
wherein the second data link is an Ethernet connection.

9. The process monitoring system in accordance with claim 1,
wherein the main sensor has a computing device that is configured to execute a web server, wherein the computing device is additionally configured to transmit the measurement data of the main sensor and the additional sensor to the data evaluation unit.

10. The process monitoring system in accordance with claim 1,
wherein the main sensor, the additional sensor, and the data evaluation unit are arranged spatially separately from one another.

11. The process monitoring system in accordance with claim 10,
wherein the main sensor, the additional sensor, and the data evaluation unit are arranged spatially separately from one another and are each integrated in separate housings.

12. The process monitoring system in accordance with claim 1,
wherein the main sensor and the additional sensor are configured to acquire mutually different physical variables as measurement data.

13. The process monitoring system in accordance with claim 1,
wherein the main sensor is a flow sensor.

14. The process monitoring system in accordance with claim 13,
wherein the flow sensor is a thermal flow meter.

15. The process monitoring system in accordance with claim 13,
wherein the flow sensor is for compressed air.

16. The process monitoring system in accordance with claim 1,
wherein the additional sensor is an electricity meter or a water meter.

17. The process monitoring system in accordance with claim 1,
wherein the data evaluation unit is formed by an edge computer or a cloud computer.

18. A main sensor for a process monitoring system for monitoring an industrial process,
wherein the main sensor is configured to acquire measurement data,
wherein the main sensor can be coupled to an additional sensor via a first data link and is configured to receive measurement data of the additional sensor via the first data link,
wherein the main sensor can be coupled to a data evaluation unit via a second data link and is configured to transmit its own measurement data and the measurement data of the additional sensor to the data evaluation unit via the second data link.

19. A method for monitoring an industrial process using a main sensor and at least one additional sensor separate from the main sensor,
wherein the main sensor and the additional sensor each acquire measurement data,
wherein the main sensor is coupled to the additional sensor via a first data link and receives the measurement data of the additional sensor via the first data link,
wherein the main sensor is coupled to the data evaluation unit via a second data link and transmits its own measurement data and the measurement data of the additional sensor to the data evaluation unit via the second data link.
